(19) United States
(12) Patent Application Publication
(10) Pub. No.: US 2006/0074664 A1
(43) Pub. Date: Apr. 6, 2006

(54) System and method for utterance verification of chinese long and short keywords

(76) Inventors: Kwok Leung Lam, Hong Kong (HK); Pascale Fung, Clear Water Bay (HK)

Correspondence Address: FOLEY HOAG, LLP;PATENT GROUP, WORLD TRADE CENTER WEST, 155 SEAPORT BLVD, BOSTON, MA, 02110, US

(21) Appl. No.: 09/758,034

(22) Filed: Jan. 9, 2001

Related U.S. Application Data
(60) Provisional application No. 60/175,464, filed on Jan. 10, 2000.

(51) Int. Cl. G10L 15/28

(52) U.S. Cl. 704/255

(57) ABSTRACT

An utterance verification system and method includes: a new formulation of log-likelihood ratio (LLR) that discriminates between true and mis-recognition scores; a new dynamic threshold setting that permits each keyword to have its own individual threshold; and/or use of higher resolution subword units for HMM based (Hidden Markov Model-based) utterance verification. The system and method are especially suited for automated processing of speech of syllable-based languages, for example, Chinese (for example, Mandarin or Cantonese).

### RELATED APPLICATIONS

The present application is related to, and claims the benefit of priority from, the following commonly-owned U.S. patent application by the same inventors, the disclosure of which are hereby incorporated by reference in its entirety, including any incorporations-by-reference, appendices, or attachments thereof, for all purposes:

Ser. No. 60/175,464, filed on Jan. 10, 2000 and entitled SYSTEM AND METHODS FOR UTTERANCE VERIFICATION OF CHINESE LONG AND SHORT KEYWORDS.

### BACKGROUND OF THE INVENTION

The present invention relates to automated processing of speech, especially automated utterance verification (UV). UV is the determining of whether a particular keyword appears within an utterance of speech. UV is typically performed by computing a log-likelihood ratio (LLR) based on an observed (i.e., heard) utterance and comparing the computed LLR with a predetermined threshold. If the LLR exceeds the threshold, then an occurrence of a keyword, which was the subject of the LLR, is detected. The LLR is computed using, in part, a pre-determined model of the hypothesized keyword.

In the Chinese languages, about 80% of words, which tend to be relatively short, contain only one to three characters, and each character is monosyllabic. In automated speech recognition of utterances of the Chinese languages, each Chinese syllable is typically modeled as an initial sound unit (phoneme) and a final sound unit (phoneme). Using this initial-final modeling, each Chinese word would typically be modeled as no more than two to six phonemes. This is relatively short compared with English words. For this reason, utterance verification (UV) of Chinese keywords performs relatively more poorly than UV of English language keywords, particularly for short Chinese utterances.

### SUMMARY OF THE INVENTION

In this document, we propose (i) a new formulation of log-likehhood ratio (LLR) that discriminates between true and mis-recognition scores; (ii) a new dynamic threshold setting that permits each keyword to have its own individual threshold; and (iii) use of higher resolution subword units for HMM based (Hidden Markov Model-based) Chinese keyword verification.

In an embodiment of the present invention, a method for speech processing includes: receiving an utterance; computing a score based on the utterance, including evaluating states of a model of a keyword; and indicating based on the score that the utterance appears to contain the keyword; wherein, in the computing step, the score is computed without requiring that a model, of speech other than the keyword, be evaluated only at states corresponding to the evaluated states of the model of the keyword.

In another embodiment of the invention, a system for speech processing includes: a processor; a memory; a model of a keyword; a model of words other than the keyword; and logic that directs the processor to read an utterance; compute a score based on the utterance and on the model of the keyword and the model of words other than the keyword; and indicate that the utterance appears to include the keyword; wherein the score is based on portions, of the model of words other than the keyword, that do not necessarily correspond to portions, of the model of the keyword, that were used to compute the score.

In another embodiment of the invention, a method for speech processing includes: receiving an utterance; for each of multiple keywords, computing a score based on the utterance; for each of multiple keywords, comparing the score to a threshold, wherein the threshold for one of the multiple keywords need not be the same as the threshold for another of the multiple keywords; and indicating based on result of the comparison that the utterance appears to contain the keyword.

In another embodiment of the invention, a speech processing system includes: a processor; a memory; logic that directs the processor to: read an utterance; for each of multiple keywords, compute a score based on the utterance and compare the score to a threshold; wherein the threshold for one of the multiple keywords need not be the same as the threshold for another of the multiple keywords; and indicating based on result of the compare that the utterance appears to contain a keyword.

In another embodiment of the invention, a method for processing speech of a language having a syllabic character set includes: maintaining models of syllables of the language, wherein syllables corresponding to some characters of the character set are modeled using at least three subword units; receiving an utterance; computing scores based on the utterance and the models; and indicating the detected existence of a word in the utterance based on the scores.

In another embodiment of the invention, a speech processing system for performing recognition on speech of a language having a syllabic character set includes: a processor; a memory; models of syllables of the language, wherein syllables corresponding to some characters of the character set are modeled using at least three subword units; and logic that directs the processor to: receive an utterance; computing scores based on the utterance and the models; and detecting existence of a word in the utterance based on the scores.

### BRIEF DESCRIPTION OF THE DRAWINGS

FIG. 1A is a block diagram of a computer system in which the present invention may be embodied.

FIG. 1B is a block diagram of a software system of the present invention for controlling operation of the system of FIG. 1A.

### DETAILED DESCRIPTION OF A PREFERRED EMBODIMENT

The following description will focus on the currently-preferred embodiment of the present invention, which is operative in an environment typically including desktop computers, server computers, and portable computing devices, occasionally or permanently connected to one another. The currently-preferred embodiment of the present invention may be implemented in an application operating in an Internet-connected environment and running under an operating system, such as the Microsoft® Windows operating system, on an IBM-compatible Personal Computer (PC) configured as an Internet server. The present invention, however, is not limited to any particular environment, device, or application. Instead, those skilled in the art will find that the present invention may be advantageously applied to any environment. For example, the present invention may be advantageously embodied on a variety of different platforms, including Macintosh, Linux, EPOC, BeOS, Solaris, UNIX, NextStep, and the like. For another example, although the following description will describe preferred embodiments that are adapted for the Chinese language, the invention itself is not limited to the Chinese language, and indeed may be embodied for other languages or dialects. The description of the exemplary embodiments which follows is, therefore, for the purpose of illustration and not limitation.

I. Introduction

The present document will use bracketed numbers, e.g., “[1]”, to refer to references whose citations appear in a numbered list near the end of the present document.

The goal of UV is to determine whether a keyword, for example, a string of one or more words, exists within an observed utterance. UV can also be used within a sentence to determine the starting and ending points of keywords. A discriminative function is typically used for rejecting/accepting an utterance based on a pre-defined threshold. The conventional discriminative function is the following LLR:

$$LLR = log \frac{P ( O \vert {H}_{0} )}{P ( O \vert {H}_{1} )}$$

where H₀ is the null hypothesis that a particular target keyword exists in an utterance O; H₁ is the alternative hypothesis that the particular target keyword does not exist in the utterance O; P(O/H₀) is the probability of the observation O assuming that the null hypothesis is true, according to a model of the target keyword; and P(O/H₁) is the probability of the observation O assuming that the alternative hypothesis is true, according to a model of “speech other than the target keyword”.

There are two types of errors leading from the discriminative function. They are (1) false rejection—where a correctly decoded keyword is rejected by the UV; and (2) false acceptance—where an incorrectly decoded keyword is accepted by the UV. From the user's point of view, a false acceptance is often unacceptable since the system should not respond to the user unless the word uttered is a real command from the user. However, there is always a trade-off between false rejection and false acceptance. In order to improve system performance, the false alarm rate is usually reduced by allowing some false rejection. Most importantly, an attempt is made to improve the overall performance of the utterance verification. An efficient verification algorithm is needed to reject those utterances which are not correct hypothesis such as (1) background noise, (2) out-of-vocabulary (OOV) words and (3) mis-recognized utterances.

Since the discriminative function based on HMMs is borrowed from the task of speaker verification, it may not be suitable for the UV task. In the speaker verification task, pre-defined command words are assumed to be given by users. However, the situation is different in the UV task. In UV, there are different types or components of utterances including (1) background noise, (2) out-of-vocubulary (OOV) words and (3) mis-recognized speech which should be rejected by the utterance verification. Therefore, we propose a new formulation of a likelihood ratio that can take into account noise and OOV utterances for utterance verification.

In the utterance verification task, short utterances contribute to the majority of the overall errors. A time-dependent threshold setting has been proposed in [4] such that the verification error due to short utterances are normalized and reduced [4, 7]. In particular, [4] proposes different rejection threshold for words of different quantized lengths. Three thresholds are set for words of lengths one, two to three, and more than three, respectively. (The lengths one, two and three refer to the length of time taken to utter the word). However, these time-dependent thresholds are still fixed for all keywords. We propose further improving the system performance by setting individual thresholds for each hypothesized keyword.

Also, the number of subword units in a keyword also affects the performance. In [7], it is shown that the smaller the number of phone units in a keyword, the higher the error rate. In light of this observation, we propose increasing the number of phone units of a keyword to improve the system performance.

The present invention may be used in a telephone speech recognition system. The user retrieves a persons' telephone number by speaking a name to the system. However, the user may also carelessly make some garbage utterances to the system. The present invention may also be used in a system for stock name information retrieval. The user speaks a stock name (e.g., in Mandarin Chinese) to the system and the system gives the stock quote to the user. However, the user may speak some non-command words while using the system.

II. Aspects and Components of the UV System

A. The Alternative Model

In order to obtain better system performance, alternative models or anti-models which generate alternative hypothesis play an important role in utterance verification. In order to reject/accept the three types of incorrect utterance, namely (1) background noise, (2) out-of-vocabulary (OOV) words and (3) mis-recognized utterances, different types of alternative models should be used. These types of anti-models are trained from particular sets of utterances. For example, filler models with a fully connected all-phone network are useful for rejecting the OOV utterances.

In some noisy environments such as telephone system and cars, the background noise will be recognized as keywords during keyword spotting. In order to reject this kind of speech, a background noise model is used as an anti-model in order to reject such kinds of utterances [7].

The filler models with a fully connected all-phone network are the most popular alternative model for OOV rejection. The likelihood of the best path generated from the Viterbi search with the filler model is used as an alternative hypothesis. The performance of the filler model is good, particularly for OOV utterances. Since the computation of the filler model is expensive, garbage (general speech) model is trained from all the speech data, or the antisubword class model is trained from the training data that does not belong to the subword class. These models which have been proposed and verified can perform as well as the filler model and are less time consuming [13].

However, the most difficult problem for utterance verification is the mis-recognized utterance. Since such an utterance can always be confused with the correct hypothesis, they are difficult to reject. As in the speaker verification task, the cohort models which are trained from the “confusable set of phonemes” are used as the anti-model to reject these mis-recognized utterances [13]. The cohort set of each phoneme, as observed from the confusion matrix, is comprised of the most confusable phonemes with respect to the correct phoneme. To further improve the performance of the utterance verification, the minimum verification error(MVE) training method is often used so that the distance between the null hypothesis and its alternative hypothesis is separated [13].

For the general speech recognition task, it is well-known that context dependent models always give a better performance than context independent models. Similarly, verification using context dependent anti-models as an alternative hypothesis also performs better than using context independent anti-models.

In our experiments, a garbage anti-model which is trained from all phonemes is used as an alternative hypothesis. It can perform as well as the filler model and has less computational time.

B. Prosodic Information Modeling

Besides using anti-models as alternative hypothesis testing, prosodic information and N-best recognition are used as complementary information for utterance verification. Prosodic information such as tone is very useful for tonal languages such as Mandarin. Other kinds of prosodic information such as time duration, pitch and energy voicing are also important for UV task. Language information can also be used to improve the performance [3, 5, 8, 2, 13, 15]. However, tone recognition in Mandarin is very difficult. Tone recognition error can lead to more errors in the UV. Hence, tone information is preferably not used for utterance verification in the present invention, for simplicity.

C. Confidence Measure Estimation

Confidence measure is a scoring method used to quantify the confidence of the utterances. In the statistical approach, different confidence scoring methods such as the frame based, the subword based, and the word based confidence measure have been proposed. Subword based confidence measure is usually more reliable than other types of the confidence measures [1, 11]. For a word with a phoneme sequence P₁, P₂, . . . , P_{N}, the phone based confidence measure is

$${LLR}_{W} = \frac{1}{N} {\sum }_{i = 1}^{N} \frac{1}{{T}_{{P}_{i}}} {LLR}_{{P}_{i}}$$

where N is the number of phones and Tᵢ is the duration for phone Pᵢ.

In the above formula, all phones are weighted equally. However, we suspect that different phones might have different impacts on the confidence measure. Different weights can be trained using the Linear Discriminative Analysis(LDA), the Artifical Neural Network (ANN), and the Gradient Probabilitic Descent (GPD) discriminative training methods.

In addition, different types of alternative hypothesis models such as filler models and cohort models can be amalgamated to form a confidence measure using the above-mentioned traning method.

D. Threshold Setting

Decision threshold setting is used to reject/accept the keyword hypothesis. For simplicity, a fixed decision threshold is usually used. However, short utterances contribute toward the majority of the overall errors. A time-dependent threshold setting which consists of several thresholds according to the length of the utterance can reduce the error due to short utterances [4]. Moreover, increasing the number of phone units of a keyword can improve the system performance. Therefore, the decision threshold based on the number of phones in the keyword has been proposed [7] to reduce the error rate due to short utterances. To further improve the system performance, we propose using a dynamic threshold for all words so that each individual word has a different threshold.

II. System Hardware

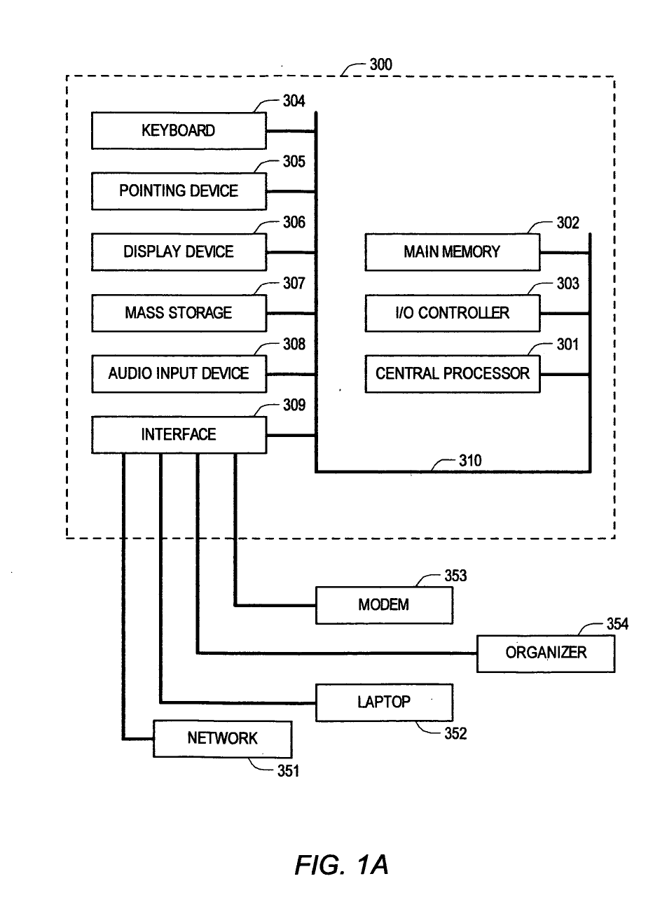

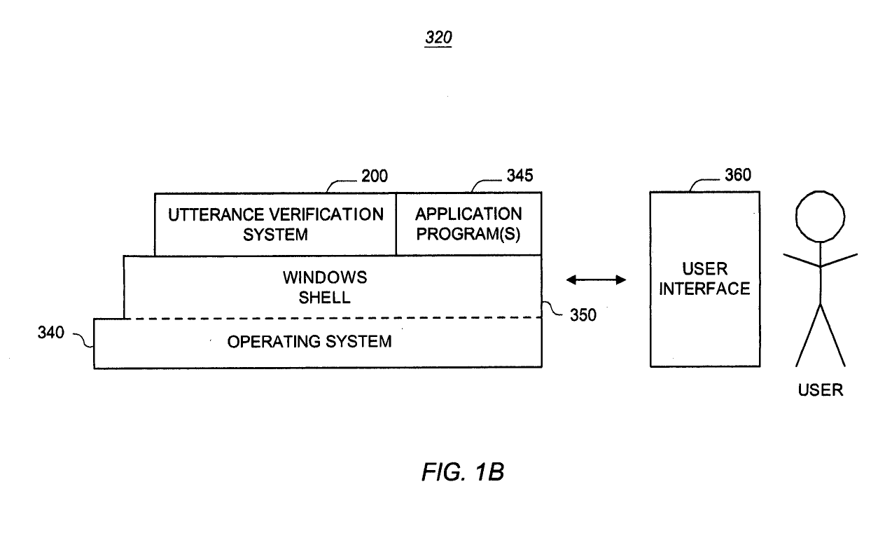

The present invention may be embodied on an information processing system such as the system 300 of FIG. 1A, which comprises a central processor 301, a main memory 302, an input/output (I/O) controller 303, a keyboard 304, a pointing device 305, pen device, or the like), a screen or display device 306, a mass storage 307 (e.g., hard disk, removable floppy disk, optical disk, magneto-optical disk, or flash memory, etc.), an audio input device 308 (e.g., a microphone, e.g., as found on a telephone that is coupled to the bus system 310), and an interface 309. Although not shown separately, a real-time system clock is included with the system 300, in a conventional manner. The various components of the system 300 communicate through a system bus 310 or similar architecture. In addition, the system 300 may communicate with other devices through the interface or communication port 309, which may be an RS-232 serial port or the like. Devices which will be commonly connected, occasionally or on a full time basis, to the interface 309 include a network 351 (e.g., LANs. or the Internet), a laptop 352, a handheld organizer 354 (e.g., the Palm organizer, available from Palm Computing, Inc., a subsidiary of 3Com Corp. of Santa Clara, Calif.), a modem 353, and the like.

In operation, program logic (implementing the methodology described below) is loaded from the storage device or mass storage 307 into the main memory 302, for execution by the processor 301. During operation of the program (logic), the user enters commands and data through (a) the keyboard 304, (b) the pointing device 305 which is typically a mouse, a track ball, or the like, and/or (c) the audio input device by voice input, and/or (d) the like. The computer system displays text and/or graphic images and other data on the display device 306, such as a cathode-ray tube or an LCD display. A hard copy of the displayed information, or other information within the system 300, may be printed to other output devices (e.g., a printer), not shown, which would be connected to the bus system 310. In a preferred embodiment, the computer system 300 includes an IBM PC-compatible personal computer (available from a variety of vendors, including IBM of Armonk, N.Y.) running a Unix operating system (e.g., Linux, which is available from Red Hat Software, of Durham, N.C., U.S.A.). In a preferred embodiment, the system 300 is an Internet or intranet or other type of network server, e.g., one connected to a worldwide publically accessible communication network, and receives input from (e.g., digitized audio voice input), and sends output to, a remote user via the interface 309 according to standard techniques and protocols.

IV. System Software

Illustrated in FIG. 1B, a computer software system 320 is provided for directing the operation of the computer system 300. Software system 320, which is stored in system memory 302 and on storage (e.g., disk memory) 307, includes a kernel or operating system (OS) 340 and a windows shell 350. One or more application programs, such as client application software or “programs” 345 may be “loaded” (i.e., transferred from storage 307 into memory 302) for execution by the system 300.

System 320 includes a user interface (UI) 360, preferably a Graphical User Interface (GUI), for receiving user commands and data and for producing output to the user. These inputs, in turn, may be acted upon by the system 300 in accordance with instructions from operating system module 340, windows module 350, and/or client application module(s) 345. The UI 360 also serves to display user prompts and results of operation from the OS 340, windows 350, and application(s) 345, whereupon the user may supply additional inputs or terminate the session. In a specific embodiment, OS 340 and windows 345 together comprise Microsoft Windows software (e.g., Windows 9x or Windows NT, available from Microsoft Corporation of Redmond, Wash.). In the preferred embodiment, OS 340 is the Unix operating system (e.g., the Linux operating system). Although shown conceptually as a separate module, the UI is typically provided by interaction of the application modules with the windows shell and the OS 340. One application program 200 is the utterance verification system according to the present invention, which will be described in further detail. While the invention is described in some detail with specific reference to preferred embodiments and certain alternatives, there is no intent to limit the invention to that particular embodiment or those specific alternatives.

V. System Structures

Our system is a Mandarin telephone speech recognition system based on phoneme continuous density hidden Markov models. Mixture Gaussian state observation density has ten mixture components per state. Each subword unit is modeled by a 3-state left-to-right HMM with no state skips. For the baseline system, initial-final segmentation is used. There are 23 initial parts and 34 final parts. In our system, initial parts are modeled by right context-dependent models. Final parts are modeled by context-independent models. The total units we used are 150 phone models.

The recognizer feature vector consists of 39 parameters: 12 Mel-warped frequency cepstra coefficients (MFCC), 12 delta cepstral coefficients, 12 delta-delta cepstral coefficients, energy, and the delta and delta-delta of the energy.

In the experiments, three sets of data are used:
1. Training set is used to train the subword models and its anti-model.
2. Development set is used to train the weighting of each phoneme.
3. Testing set is used to evaluate the performance of utterance verificaiton.

Two test sets are formed:
1. Confusable Test: Mis-recognized and most confusable speech utterances are used for evaluating the performance.
2. Garbage Speech Test: Since our task is telephone speech recognition, many users will say non-command speech. This kind of utterance is used to perform recognition and its recogntion result is used as transcription. A garbage anti-model is used as an anti-model. It is modeled by a 3-state left-to-right HMM with 64 mixture components per state. It is trained by all phone segments in the training set.
   VI. Improved LLR-Based UV
   A. Conventional LLR

The conventional technique of verification uses a log likelihood ratio (LLR) as a confidence measure. The most commonly used confidence measure as the discriminative function, as has been discussed above, is

$$LLR = log \frac{P ( O \vert {H}_{0} )}{P ( O \vert {H}_{1} )}$$

For implementation based on HMMs, the above LLR becomes, for a frame t (small timeslice) of input:

$${LLR}_{old} = log \frac{{b}_{j}^{c} ( {o}_{t} )}{{max}_{m = 1}^{M} {b}_{j}^{m} ( {o}_{t} )}$$

where bⱼ(oₜ) is the observation probability in state j at frame t, c is the correct model and M is the number of models except the correct model.

However, this type of LLR may not be appropriate for decoding since an alternative hypothesis is not modeled well. The problem is due to the fact that the alternative model always follows the same state as the target model. In some cases, the traditional LLR does not find the most representative alternative hypothesis, so the decoding task based on LLR can not perform as well as a likelihood.

B. Our Improved LLR

In response to the deficiency noted in the previous section with the conventional LLR, we propose an LLR-based utterance verification so as to have the discriminative function that is consistent with the likelihood in the decoding task.

The traditional LLR is inconsistent with the likelihood. Since the alternative model always follows the same state as the target model, it does not always give an optimal score in a global observation space. Instead, the score is a local maximum in an observation space within a particular state.

We propose a LLR based utterance verification to make it more consistent with the likelihood and more optimal in the observation space. At the same time, performance can be improved. To achieve this goal, the LLR based UV is:

$${LLR}_{new} = log \frac{{b}_{j}^{c} ( {o}_{t} )}{{max}_{m = 1}^{M} {max}_{k = 1}^{N} {b}_{k}^{m} ( {o}_{t} )}$$

where N is the number of states and M is the number of models other than the target model. Thus, the new LLR formulation uses an alternative model (i.e., a model for “speech other than the keyword”), but does not require that the alternative model be evaluated only at the same corresponding states that are evaluated in the hypothesized keyword's model.

However, this type of LLR is computationally expensive since the computation time is N times more than the traditional LLR. For this reason, an anti-model may be used instead of using the M models.

The proposed LLR is then simplified to the following:

$${LLR}_{new} = log \frac{{b}_{j}^{c} ( {o}_{t} )}{{max}_{k = 1}^{N} {b}_{k}^{a} ( {o}_{t} )}$$

where N is the number of states and a is the alternative model.
C. Phone Based Confidence Measure

Since our task is based on subword units HMMs. The confidence measure for the word string is computed based on the confidence score of the subword units, as follows:

$${LLR}_{subword} = \frac{1}{T} {\sum }_{t = 1}^{T} log \frac{{b}_{j} ( {o}_{t} )}{{max}_{k = 1}^{N} {b}_{k}^{a} ( {o}_{t} )}$$

where N is the number of states of each model and T is the duration of the subword model.

The normalized LLR_{word} is used as the confidence measure for the verification, as follows:

$${NormalizedLLR}_{word} = \frac{1}{N} {\sum }_{n = 1}^{N} {LLR}_{n}$$

where T is the duration of the word string and N is the number of subword units for the word string. The sigmoid function is used so as to limit a dynamic range of the confidence measure to the range from 0 to 1, as follows:

$$sigmoid ( x ) = \frac{1}{1 + exp ( - x )}$$

where ë is the slope of the sigmoid function and x is a confidence measure.

In order to have a more efficient likelihood ratio, a garbage anti-model which is trained from all phonemes is used as an alternative hypothesis instead of using other kind of anti-model such as cohort and subword class anti-model [13]. Comparison has been made between the traditional LLR and our novel LLR using a garbage anti-model which is trained from all phonemes. There is significant improvement with our novel LLR.

VII. Dynamic Threshold Setting for Improved UV

A. Feature Transformation

In the earlier-shown equation for Normalized LLR_{word}, all phonemes are weighted equally. In order to weight each phoneme according to its impact toward the confidence score, we can modify the confidence measure as follows.

For the word W with a phoneme sequence P₁, P₂, . . . , P_{N},

$$CS ( W ) = \frac{1}{N} {\sum }_{i = 1}^{N} {f}_{{P}_{i}} ( {X}_{i} )$$

where f_{Pi} is the function of the phone class i and Xᵢ can be the likelihood ratio of the phoneme i.

Suppose the function is a linear transformation: f(x)=ax+b, where a and b are estimated using the gradient probabilistic descent discriminative training framework [5, 13]. In our experiment, the gradient probabilitic descent (GPD) discriminative training is used to train the weights a and b.

B. Dynamic Threshold Setting

To classify whether a spoken utterance is a keyword or non-keyword, a decision threshold is needed. It is common to use a same trained threshold for all keywords [9, 13]. Although this is simple and efficient, it sacrifices the overall performance. We propose a dynamic threshold for individual keywords to improve the performance.

Since our task is based on subword unit HMMs, the confidence measure for the word string is computed based on the confidence score of the subword units. We use an LLR formulation proposed in our previous work for computing the confidence score [9]. Also, the phone based confidence score with linear transformation is used as confidence measure.

For the word W with a phoneme sequence P₁, P₂, . . . , P_{N}, Y is the confidence score of W:

$$Y = \frac{1}{N} {\sum }_{i = 1}^{N} {f}_{{P}_{i}} ( {X}_{i} )$$

where f_{Pi} is the linear function of the phoneme i and Xᵢ is the likelihood ratio of the phoneme i.

In order to find a threshold for each keyword, we consider the verification task as the classification problem between “keyword” and “non-keyword” classes. If the conditional probability density functions (CPDFs) for each keyword are known for these two classes, the threshold for each keyword can be calculated using the Bayes' decision rule. Here, we consider a word based confidence score Y as a random variable and compute Y from a phoneme confidence score X which is also a random variable. The CPDFs of the keyword score Y can be calculated as the convolution of the scaled CPDFs of the constituent phonemes using a Gaussian distribution N(μ, ó) for all phoneme CPDFs. Y is therefore also a Gaussian distribution,

$$Y = N ( \frac{1}{N} {\sum }_{i = 1}^{N} ( {a}_{i} {μ}_{i} + {b}_{i} ) , \frac{1}{N} \sqrt{{\sum }_{i = 1}^{N} ( {a}_{i}^{2} {σ}_{i}^{2} )}$$

Parameters μᵢ and óᵢ are measured once before calculating the CPDFs of keywords.

The Bayes' decision rule is used as the discriminative function:
CS(Y)=log P(Y|keyword)−log P(Y|nonkeyword)

The detailed formulation of the above discriminative function is as follows:

$$CS ( Y ) = - \frac{1}{2} ( log ( 2 π {σ}_{W}^{2} ) + {( \frac{Y - {σ}_{W}}{{σ}_{W}} )}^{2} ) + \frac{1}{2} ( log ( 2 π {σ}_{\underline{W}}^{2} ) + {( \frac{Y - {σ}_{\underline{W}}}{{σ}_{\underline{W}}} )}^{2} )$$

where Y is the confidence score of a keyword W; ó_{W} and μ_{W} are the standard deviation and the mean of the keyword W's CPDF; and ó_{W} and μ_{W} are the standard deviation and the mean of the non-keyword W's CPDF.

Since the CPDFs for the two classes “keyword” and “non-keyword” and the a-priori probabilities can be calculated by the above equation for CS(Y), the Bayes risk is used to set the threshold for Y. Every keyword threshold can be computed using the invert function of the above equation for CS(Y) once the equation is established from a training process.

Since confusable training set is used for calculating both the CPDF of “keyword” and “non-keyword”, the CPDFs may not be suitable for dealing with the garbage speech utterances. However, we can see that the dynamic threshold method can handle the garbage speech as well as the conventional phone based confidence measure.

Moreover, we see that the dynamic threshold setting performs better for long utterances and the results from short utterances is similar to the phone based confidence measure. The reason is that when the length of a keyword increases, the variance of a keyword and a non-keyword's CPDF decreases. In other words, the reliability of a keyword confidence score increases when the length of the keyword increases. In this case, the system performance improves when the length of the keyword increases.

VIII. High Resolution Subword Units for Short Keyword Utterance Verification

1. Motivation

Due to the lack of natural boundaries for “words” in Chinese, it is usually assumed that a single character is a word. In conventional Mandarin speech recognition systems, such single character words are further divided into initials and finals as subword units. There are 24 initials and 33 finals in Mandarin Chinese speech, if tone differences are ignored.

For an initial-final subword unit-based HMM recognizer, it is necessary to train HMM models of initials and finals. Consequently, it is necessary to divide acoustic signals into initial and final segments. For example, the term “Hong Kong University of Science and Technology”, pronounced in Mandarin, in terms of single character words is (1) xiang1 gang3 ke1 ji4 da4 xue2, and in terms of toneless subword units is (2) x iang g ang k e j i d a x ue. In initial/final based segmentation, a phonetic dictionary is used to generate (1) and then (2). (2) is then used as the phonetic transcription reference. The segmentation process becomes a Viterbi-based alignment of the acoustic data with the phonetic transcription. The goal is to obtain an optimal sequence of boundaries dividing the acoustic signal for (1) into (2).

For our experiments, we use HKU93—A Putonghua Corpus with 4931 single character samples, corresponding to 398 unique Ping-Yins, from four female speakers and 4 male speakers. We use the above initial/final table to transcribe all the Ping-Yins. We use the HTK toolkit to train initial/final HMMs. Since the program HERest uses embedded training, we do not get initial/final boundaries explicitly at the training stage. In order to retrace these boundaries, we use a Viterbi program HVite to align phonetic transcriptions to the acoustic data again. The aligned segments are used to train Hidden Markov Models of initials and finals.

Such a segmentation process requires explicit knowledge of the initials and finals and is considered as a template matching approach [14]. From our segmented training data, we can see that the acoustic boundaries obtained from this process is not optimal. Sometimes the initial/final boundaries clearly do not correspond to the natural spectral boundaries.

The above-discussed segmentation result motivates us to reconsider using initial/final units as subword units for Mandarin speech recognition. Another motivation comes from the fact that even when the initial/final boundary is correct, the final unit is not always a single phoneme, such as a, i, e, o, u, and ü, but a concatenation of vowels and consonants such as ang, er, iang, iong. Whether the latter group can be considered as a single subword unit or not is subjective. In fact, we observe that the error in initial/final segmentation usually comes from confusing the final vowel/consonant boundary with the initial/final boundary.

B. High Resolution Subword Unit HMMs

In view of the above-described motivation, we propose splitting the final unit into several parts so as to improve the system performance. For simplicity, All final parts are split into two parts, i.e., two phonemes, except the finals a, i, e, o, u, and ü, which are fundamental phonemes in Mandarin. The initial part continues to be modeled by right context-dependent HMMs. All sub-phonemes of the final and initial parts are modeled by 3-state HMMs. In this way, the number of phonemes of the keyword increases so the reliability of the keyword increases.

### IX. Further Comments

The automated utterance verification according to the present invention may be used, for example, within a distributed speech recognition system, or other speech recognition system, for example, as discussed in the co-owned and co-pending U.S. patent application Ser. No. 09/613,472, filed on Jul. 11, 2000 and entitled “SYSTEM AND METHODS FOR ACCEPTING USER INPUT IN A DISTRIBUTED ENVIRONMENT IN A SCALABLE MANNER”, hereinafter referred to as the USER INPUTREFERENCE, which is hereby incorporated by reference in its entirety for all purposes. The automated utterance verification according to the present invention for use within the speech recognition system(s) of the USER INPUT REFERENCE are preferably set up as discussed in the USER INPUTREFERENCE. The automated utterance verification according to the present invention may also be used, for example, within the speech processing systems that are discussed in U.S. patent Ser. No. ______, attorney docket number WIW-002.01, filed on <the same day as the present application> and entitled SYSTEM AND METHOD FOR SPEECH PROCESSING WITH LIMITED TRAINING DATA, hereinafter referred to as the LIMITED TRAINING REFERENCE, which is hereby incorporated by reference in its entirety for all purposes. The established automated keyword spotting system for use within the speech recognition system(s) of the LIMITED TRAINING REFERENCE are preferably set up as discussed in the LIMITED TRAINING REFERENCE.

While the invention is described in some detail with specific reference to preferred embodiments and certain alternatives, there is no intent to limit the invention to those particular embodiments or specific alternatives. Thus, the true scope of the present invention is not limited to any one of the foregoing exemplary embodiments but is instead defined by the appended claims.

### REFERENCES

[1] Giulia Bernardis and Herve Bourlard. Improving posterior based confidence measures in hybrid hmm/ann speech recognition systems. In ICSLP, 1998.
[2] J. Caminero, C. de la Torre, L. Villarrubia, C. Martin, and L. Hernandez. On-line garbage modeling with discriminant analysis for utterance verification. In ICSLP, 1996.
[3] J. G. A. Dolfing and A. Wendemuth. Combination of confidence measures in isolated word recognition. In ICSLP, 1998.
[4] Sunil K. Gupta and Frank K. Soong. Improved utterance rejection using length dependent thresholds. In ICSLP, 1998.
[5] Li Jiang and Xuedong Huang. Vocabulary-independent word confidence measure using subword features. In ICSLP, 1998.
[6] Taktoshi JITSUHIRO, Satoshi Takehasi, and Kiyoaki Aikawa. Rejection of out-of-vocabulary words using phoneme confidence liklihood. In ICASSP, 1998.
[7] D. Jouvet, K. Bartkova, and G. Mercier. Hypothesis dependent threshold setting for improved out-of-vocabulary data rejection. In ICASSP, 1999.
[8] Katrin Kirchoff and Jeff A. Bilmes. Dynamic classifier combination in hybrid speech recognition systems using utterance-level confidence values. In ICASSP, 1999.
[9] Lam Kwok Leung and Pascale Fung. A more optimal and efficient llr for decoding and verification. In ICASSP, 1999.
[10] Padma Ramesh, Chin hui Lee, and Biing-Hwang Juang. Context dependent anti subword modeling for utterance verification. In ICSLP, 1998.
[11] Ze'ev Rivlin, Michael Cohen, Victor Abrash, and Thomas Chung. A phone-dependent confidence measure for utterance rejection. In ICASSP, 1996.
[12] R. C. Rose, H. Yao, G. Roccardi, and J. Wright. Integration of utterance verification with statistical language modeling and spoken language understanding. In ICASSP, 1998.
[13] Rafid A. Sukkar and Chin-Hui Lee. Vocabulary independent discriminative utterance verification for nonkeyword rejection in subword based speech recognition. In ICASSP, 1996.
[14] Torbjorn Svendsen and Frank K. Soong. On the automatic segmentation of speech signals. In Proceedings of ICASSP 87, 1987.
[15] A. Wendemuth, G. Rose, and J. G. A. Dolfing. Advances in confidence measures for large vocabulary. In ICASSP, 1999.
[16] Sheryl R. Young. Detecting misrecognitions and out-of-vocabulary words. In ICASSP, 1994.

The above references are hereby incorporated by reference in their entirety for all purposes.

What is claimed is:

1. In an information processing system, a method for speech processing, the method comprising:
receiving an utterance;
computing a score based on the utterance, including evaluating states of a model of a keyword; and
indicating based on the score that the utterance appears to contain the keyword;
wherein, in the computing step, the score is computed without requiring that a model, of speech other than the keyword, be evaluated only at states corresponding to the evaluated states of the model of the keyword.

2. The method of claim I wherein the computing step includes:
evaluating a state j of the model of the keyword for each timeslice t of multiple timeslices of the utterance;
evaluating a state k of a model, of speech other than the keyword, at the timeslice t, wherein the state k is chosen to maximize or minimize a value without requiring that the state k equal the state j.

3. The method of claim 2 wherein the computing steps includes computing a value based on the expression:
$$\frac{{b}_{j}^{c} ( {o}_{t} )}{{max}_{k = 1}^{N} {b}_{k}^{a} ( {o}_{t} )}$$
where bⱼ(oₜ) is the observation probability in the state j at frame t; c indicates the model of the keyword; α indicates the model of speech other than the keyword; and N is a number of states in the model of speech other than the keyword.

4. A system for speech processing, comprising:
a processor;
a memory;
a model of a keyword;
a model of words other than the keyword; and
logic that directs the processor to read an utterance; compute a score based on the utterance and on the model of the keyword and the model of words other than the keyword, and indicate that the utterance appears to include the keyword;
wherein the score is based on portions, of the model of words other than the keyword, that do not necessarily correspond to portions, of the model of the keyword, that were used to compute the score.

5. The system of claim 4 wherein the logic is configured to direct the processor to evaluate a state j of the model of the keyword for each timeslice t of multiple timeslices of the utterance and to evaluate a state k of the model of words other than the keyword at the timeslice t, wherein the state k is chosen to maximize or minimize a value without requiring that the state k correspond to the state j.

6. The system of claim 5 wherein the logic is configured to direct the processor to compute a value based on the expression:
$$\frac{{b}_{j}^{c} ( {o}_{t} )}{{max}_{k = 1}^{N} {b}_{k}^{a} ( {o}_{t} )}$$
where bⱼ(oₜ) is the observation probability in the state j at frame t; c indicates the model of the keyword; a indicates the model of speech other than the keyword; and N is a number of states in the model of speech other than the keyword.

7. In an information processing system, a method for speech processing comprising:
receiving an utterance;
for each of multiple keywords, computing a score based on the utterance
for each of multiple keywords, comparing the score to a threshold, wherein the threshold for one of the multiple keywords need not be the same as the threshold for another of the multiple keywords; and
indicating based on result of the comparison that the utterance appears to contain the keyword.

8. The method of claim 7 wherein the threshold for the one keyword and for the other keyword are each set using training data based on Bayes risk and on the conditional probability distribution function of the keyword discriminative function for the respective keyword.

9. A speech processing system, comprising:
a processor;
a memory;
logic that directs the processor to:
read an utterance;
for each of multiple keywords, compute a score based on the utterance and compare the score to a threshold;
wherein the threshold for one of the multiple keywords need not be the same as the threshold for another of the multiple keywords; and
indicating based on result of the compare that the utterance appears to contain a keyword.

10. The system of claim 9 wherein the threshold for the one keyword and for the other keyword are each set using training data based on Bayes risk and on the conditional probability distribution function of the keyword discriminative function for the respective keyword.

11. In an information processing system, a method for processing speech of a language having a syllabic character set, comprising:
maintaining models of syllables of the language, wherein syllables corresponding to some characters of the character set are modeled using at least three subword units;
receiving an utterance;
computing scores based on the utterance and the models; and
indicating the detected existence of a word in the utterance based on the scores.

12. The method of claim 11 wherein the language is Chinese.

13. The method of claim 11 wherein the language is Mandarin Chinese.

14. The method of claim 11 wherein the three subword models are hidden Markov models and comprise a context-dependent initial model.

15. A speech processing system for performing recognition on speech of a language having a syllabic character set, the system comprising:
a processor;
a memory;
models of syllables of the language, wherein syllables corresponding to some characters of the character set are modeled using at least three subword units; and
logic that directs the processor to:
receive an utterance;
computing scores based on the utterance and the models; and
detecting existence of a word in the utterance based on the scores.

16. The system of claim 15 wherein the language is Chinese.

17. The system of claim 15 wherein the language is Mandarin Chinese.

18. The system of claim 15 wherein the three subword models are hidden Markov models and comprise a context-dependent initial model.
